(19) United States
(12) Patent Application Publication
(10) Pub. No.: US 2016/0288282 A1
(43) Pub. Date: Oct. 6, 2016

(54) Turnover Fixture for Wheel Character Carving

(71) Applicant: CITIC Dicastal CO., LTD, Qinhuangdao (CN)

(72) Inventors: Weidong Liu, Qinhuangdao (CN); Fengyan Liu, Qinhuangdao (CN); Jiandong Guo, Qinhuangdao (CN); Xiaoguang Huang, Qinhuangdao (CN); Bowen Xue, Qinhuangdao (CN); Zhihua Zhu, Qinhuangdao (CN); Yongning WANG, Qinhuangdao (CN); Changhai Li, Qinhuangdao (CN)

(73) Assignee: CITIC Dicastal CO., LTD, Qinhuangdao (CN)

(21) Appl. No.: 15/088,570

(22) Filed: Apr. 1, 2016

(30) Foreign Application Priority Data
Apr. 3, 2015 (CN) 201510154121.6

(51) Int. Cl. B23Q 1/48; B60B 27/00; B23Q 3/06

(52) U.S. Cl. CPC B23Q 1/48; B23Q 3/062; B60B 27/00; B60B 2310/646

(57) ABSTRACT

A turnover fixture for wheel character carving. A rotation air cylinder and an angle block are mounted on a base, a first rotation shaft and a rotation shaft are connected with the rotation air cylinder through a rotation arm, the first rotation shaft and the base are connected through an end cover and a bearing, a support is fixed on the first rotation shaft.

### TECHNICAL FIELD

The present invention relates to a fixture, and in particular to a fixture for machining.

### BACKGROUND ART

In the industry for manufacturing automobile hubs, characters need to be carved on a certain position of a wheel to meet the requirement of the machining technology. Since the angle of a wheel position for character carving is variable, the turnover angle of the wheel needs to be regulated according to the structure and position for character carving of the wheel during character carving on the wheel. The present invention provides a turnover fixture for character carving, which effectively solves this problem.

### SUMMARY OF THE INVENTION

An object of the present invention is to provide a turnover fixture for wheel character carving.

In order to achieve the object described above, a technical solution of the present invention is as follows: a turnover fixture for wheel character carving is composed of a base, a rotation air cylinder, a support, an end cover, a rotation arm, a bearing, a rotation shaft A, a base plate, a press claw, a press claw pad, a rotation shaft B, an angle block, a slide carriage frame, an oil cylinder, a slide carriage, and a T-type nut. The rotation air cylinder and the angle block are mounted on the base, the rotation shaft A and the rotation shaft B are connected with the rotation air cylinder through the rotation arm, the rotation shaft A and the base are connected through the end cover and the bearing, the support is fixed on the rotation shaft A, and after the air cylinder is charged with air, the rotation air cylinder can drive the base plate to rotate around the rotation shaft A; the slide carriage frame is fixed on the base plate, the slide carriage is mounted on the base plate through the T-type nut, the oil cylinder and the press claw are mounted on the slide carriage, the press claw pad is fixed at one end of the press claw, the press claw can be controlled to compress or release through the oil cylinder, and the slide carriage can move in a chute formed by the slide carriage frame and the base plate, and meanwhile, can be fixed at a position on the base plate through the T-type nut. The wheels of different sizes can be positioned by regulating the position of the slide carriage. A sector region with an included angle A exists between the angle block and the rotation shaft B, the included angle A is a turnover angle of the fixture, and the rotation angle of the fixture can be regulated by changing the angle block.

During actual use, the wheel is placed on the slide carriage, the oil cylinder drives the press claw to press the wheel, then the rotation air cylinder is charged with air to drive the base plate to rotate around the rotation shaft A, and the rotation air cylinder drives the wheel to rotate around the rotation shaft B.

When the rotation is performed by the degrees of A, the angle block prevents the rotation shaft B from rotation. At this point, the wheel turnover work is completed, and a character caraving machine begins to perform character carving on the wheel

The turnover fixture provided by the present invention can meet the requirement of wheel character carving, and simultaneously has the characteristics of simple structure, convenient manufacture, stable performance, and availability for meeting a machining requirement on precision.

### BRIEF DESCRIPTION OF DRAWINGS

FIG. 1 is a structural schematic diagram of a turnover fixture for wheel character carving.

FIG. 2 is a structural schematic diagram of fitting between an angle block and a rotation shaft B in a turnover fixture for wheel character carving.

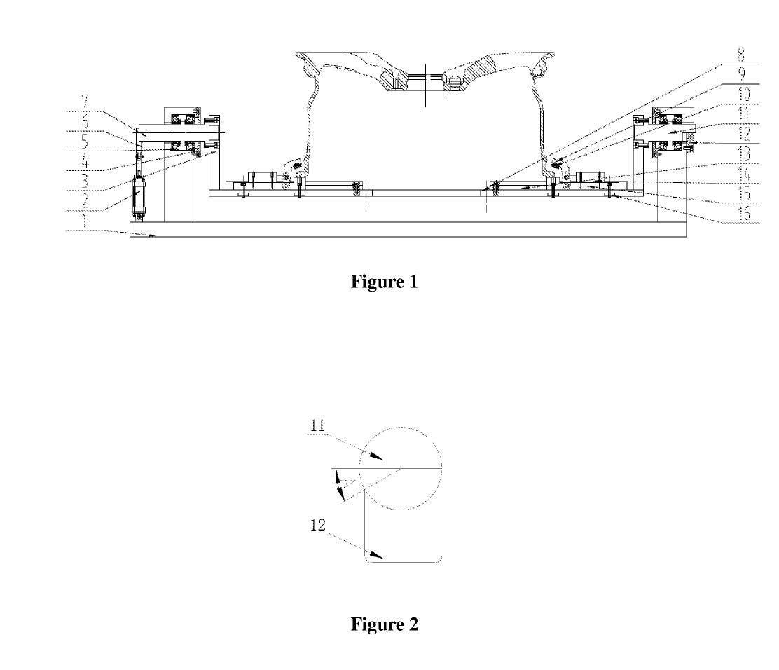

In the figure, the numeric symbols are as follows: 1-base, 2-rotation air cylinder, 3-support, 4-end cover, 5-rotation arm, 6-bearing, 7-rotation shaft A, 8-base plate, 9-press claw, 10-press claw pad, 11-rotation shaft B, 12-angle block, 13-slide carriage frame, 14-oil cylinder, 15-slide carriage, and 16-T-type nut.

### DETAILED DESCRIPTION OF THE INVENTION

In the following, the details and working conditions of a specific device provided by the present invention are described in detail in combination with the figures.

A turnover fixture for wheel character carving is composed of a base 1, a rotation air cylinder 2, a support 3, an end cover 4, a rotation arm 5, a bearing 6, a rotation shaft A 7, a base plate 8, a press claw 9, a press claw pad 10, a rotation shaft B 11, an angle block 12, a slide carriage frame 13, an oil cylinder 14, a slide carriage 15, and a T-type nut 16. The rotation air cylinder 2 and the angle block 12 are mounted on the base 1, the rotation shaft A7 and the rotation shaft B11 are connected with the rotation air cylinder 2 through the rotation arm 5, the rotation shaft A7 and the base 1 are connected through the end cover 4 and the bearing 6, the support 3 is fixed on the rotation shaft A7, and after the air cylinder is charged with air, the rotation air cylinder 2 can drive the base plate 8 to rotate around the rotation shaft A7; the slide carriage frame 13 is fixed on the base plate 8, the slide carriage 15 is mounted on the base plate 8 through the T-type nut 16, the oil cylinder 14 and the press claw 9 are mounted on the slide carriage 15, the press claw pad 10 is fixed at one end of the press claw 9, the press claw 9 can be controlled to compress or release through the oil cylinder 14, the slide carriage 15 can move in a chute formed by the slide carriage frame 13 and the base plate 8, and meanwhile, can be fixed at a certain position on the base plate 8 through the T-type nut 16. The wheels of different sizes can be positioned by regulating the position of the slide carriage 15. A sector region with an included angle A exists between the angle block 12 and the rotation shaft B 11, the included angle A is a turnover angle of the fixture, and the rotation angle of the fixture can be regulated by changing the angle block 12.

During actual use, the wheel is placed on the slide carriage 15, the oil cylinder 14 drives the press claw 9 to press the wheel, then the rotation air cylinder 2 is charged with air to drive the base plate 8 to rotate around the rotation shaft A7, and the rotation air cylinder 2 drives the wheel to rotate around the rotation shaft B11. When the rotation is performed by the degrees of A, the angle block 10 prevents the rotation shaft B11 from rotation. At this point, the wheel turnover work is completed, and a character carving machine begins to perform character carving on the wheel

1. A turnover fixture for wheel character carving: comparing: a base, a rotation air cylinder, a support, an end cover, a rotation arm, a bearing, a rotation shaft A, a base plate, a press claw, a press claw pad, a rotation shaft B, an angle block, a slide carriage frame, an oil cylinder, a slide carriage, and a T-type nut; wherein the rotation air cylinder and the angle block are mounted on the base, and the rotation shaft A and the rotation shaft B are connected with the rotation air cylinder through the rotation arm; the rotation shaft A and the base are connected through the end cover and the bearing, and the support is fixed on the rotation shaft A; the slide carriage frame is fixed on the base plate, the slide carriage is mounted on the base plate through the T-type nut, the oil cylinder and the press claw are mounted on the slide carriage, the press claw pad is fixed at one end of the press claw, the slide carriage can move in a chute formed by the slide carriage frame and the base plate, and the slide carriage is fixed at a certain position on the base plate through the T-type nut.

2. The turnover fixture for wheel character carving according to claim 1, wherein the rotation air cylinder drives the base plate to rotate around the rotation shaft A.

3. The turnover fixture for wheel character carving according to claim 1, wherein the rotation air cylinder drives a wheel to rotate around the rotation shaft B.

4. The turnover fixture for wheel character carving according to claim 1, wherein a sector region with an included angle A exists between the angle block and the rotation shaft B, and the angle block is changeable and can be used to regulate a rotation angle of the fixture.
